(19) United States
(12) Patent Application Publication
(10) Pub. No.: US 2026/0135154 A1
(43) Pub. Date: May 14, 2026

(54) SECONDARY BATTERY

(71) Applicant: DENSO CORPORATION, Kariya-city (JP)

(72) Inventors: Akihiro WATANABE, Kariya-city (JP); Shuhei YOSHIDA, Kariya-city (JP)

(21) Appl. No.: 19/381,029

(22) Filed: Nov. 6, 2025

(30) Foreign Application Priority Data
Nov. 14, 2024 (JP) 2024-198985

(51) Int. Cl. H01M 10/0583; H01M 10/0562

(52) U.S. Cl. CPC H01M 10/0583; H01M 10/0562

(57) ABSTRACT

A secondary battery includes a positive electrode, a negative electrode, a separator, and a gel polymer electrolyte. The positive electrode and the negative electrode are stacked alternately with the separator interposed therebetween. The separator has first portions between which at least one of the positive electrode or the negative electrode is arranged, and a second portion bent to connect the first portions. Each of the positive electrode and the negative electrode has a bent-side peripheral portion including a bent-side end positioned to face the second portion. An inorganic solid electrolyte is contained in the bent-side peripheral portion of at least one of the positive electrode or the negative electrode.

### CROSS REFERENCE TO RELATED APPLICATION

This application is based on Japanese Patent Application No. 2024-198985 filed on November 14, 2024, the disclosure of which is incorporated herein by reference.

### TECHNICAL FIELD

The present disclosure relates to a secondary battery.

### BACKGROUND

In a lamination-type secondary battery, a positive electrode and a negative electrode are stacked with each other through a strip-shaped separator folded in a zigzag pattern.

### SUMMARY

According to one aspect of the present disclosure, a secondary battery includes an electrode, a separator, a gel polymer electrolyte, and an exterior body that houses the electrode, the separator, and the gel polymer electrolyte. The electrode includes a positive electrode containing a positive electrode active material and a negative electrode containing a negative electrode active material. The positive electrode and the negative electrode are stacked alternately with the separator interposed therebetween. The separator has first portions between which at least one of the positive electrode or the negative electrode is arranged, and a second portion bent to connect the first portions of the separator. The electrode has a bent-side peripheral portion including a bent-side end positioned to face the second portion of the separator. An inorganic solid electrolyte may be contained in the bent-side peripheral portion of at least one of the positive electrode or the negative electrode.

### BRIEF DESCRIPTION OF DRAWINGS

FIG. 1 is a cross-sectional view of a secondary battery according to a first embodiment.

FIG. 2 is a cross-sectional view showing electrodes stacked with each other in the secondary battery.

FIG. 3 is a plan view of an electrode.

FIG. 4 is a diagram showing a mixture of a positive electrode material or a negative electrode material with an inorganic solid electrolyte.

FIG. 5 is a diagram showing a surface of a positive electrode material or a negative electrode material covered with an inorganic solid electrolyte.

FIG. 6 is a diagram showing a surface of a separator covered with an inorganic solid electrolyte.

FIG. 7 is a flowchart showing a manufacturing process of a secondary battery.

FIG. 8 is a diagram illustrating a process for producing a positive electrode and a negative electrode.

FIG. 9 is a diagram showing output characteristics and cycle characteristics of Examples and Comparative Examples.

### DETAILED DESCRIPTION

In a lamination-type secondary battery, a positive electrode and a negative electrode are stacked with each other through a strip-shaped separator folded in a zigzag pattern. By stacking electrodes using the zigzag separator, the process of cutting the separator is unnecessary, making it possible to reduce the size of the manufacturing equipment and improve productivity. In order to prevent a short circuit caused by the separator entrapped in the electrodes, when the separator deforms due to thermal shrinkage or the like, a distance between an end of the electrode and a bent portion of the separator may be optimized to a predetermined value.

A gel polymer electrolyte, which is a mixture of a non-aqueous electrolyte and a polymer, is used as a solid electrolyte for the secondary battery. When a gel polymer electrolyte is used, the electrolyte is held by the gel polymer, thereby preventing leakage, and safety can be improved by using a non-flammable polymer material. The viscosity of the gel polymer electrolyte may be controlled. It may be possible to preliminarily incorporate microcapsules, which act as a gelation initiator, into the electrolyte, and then, after the electrolyte is injected, heat or pressure is applied to the microcapsules to gradually start the gelation inside.

When a gel polymer electrolyte is used in a lamination-type secondary battery, a laminate of electrodes and separators is inserted into an exterior body, and an electrolyte material is injected. The exterior body is vacuum sealed, and then the electrolyte material is gelled. During vacuum sealing, the laminate is subjected to a confining pressure from the exterior body. Since the electrolyte material is pushed toward the outer periphery of the electrode, the amount of electrolyte material tends to increase at the outer periphery of the electrode.

In the outer periphery of the electrode, the amount of heat generated is large during the temperature increase process for gelling the electrolyte material. The gelation progresses more rapidly in the outer periphery than in the central portion, making it easier for the viscosity to increase. Because highly viscous gels inhibit ion transport, the ion transport resistance is greater at the outer periphery of the electrode than at the central portion, resulting in uneven current density during charging and discharging. The unevenness in current density of the electrode leads to a decrease in the output characteristics of the secondary battery and localized deterioration of the active material, resulting in a decrease in the cycle characteristics.

In a lamination-type secondary battery, the separator has a U-shaped bent portion at a position away from the end of the electrode, and a space is formed between the end of the electrode and the bent portion of the separator. When a gel polymer electrolyte is used in a lamination-type secondary battery, the electrolyte material is held in the space between the electrode and the separator, and the highly viscous gel polymer electrolyte is likely to accumulate. Therefore, when the separator is thermally shrunk, the highly viscous gel polymer electrolyte is forced onto the outer periphery of the electrode from the bent portion of the separator. In this case, resistance becomes particularly large in the outer periphery of the electrode connected to the bent portion of the separator, and the unevenness in current density of the electrode tends to become large.

When a gel polymer electrolyte is used in a lamination-type secondary battery, the low-viscosity electrolyte is easily pushed toward the outer periphery of the electrode due to the restraining pressure of the exterior body, making it difficult to eliminate uneven current density in the electrode.

When a gel polymer electrolyte is used in a lamination-type secondary battery, the microcapsules are easily pushed toward the outer periphery of the electrode by the restraining pressure of the exterior body, making it difficult to eliminate uneven current density in the electrode. Even if the microcapsules are preliminarily arranged locally on the electrode, the microcapsules are caught in the flow of the electrolyte when the electrolyte is injected, making localized arrangement difficult.

The present disclosure provides a secondary battery using a gel polymer electrolyte, to improve the output characteristics and cycle characteristics.

According to one aspect of the present disclosure, a secondary battery includes an electrode, a separator, an ionically conductive gel polymer electrolyte, and an exterior body that houses the electrode, the separator, and the gel polymer electrolyte. The electrode includes a positive electrode containing a positive electrode active material and a negative electrode containing a negative electrode active material. The positive electrode and the negative electrode are stacked alternately with the separator interposed therebetween. The separator has first portions between which at least one of the positive electrode or the negative electrode is arranged, and a second portion bent to connect the first portions of the separator. The electrode has a bent-side peripheral portion including a bent-side end positioned to face the second portion of the separator. An inorganic solid electrolyte is contained in the bent-side peripheral portion of at least one of the positive electrode or the negative electrode.

This makes it possible to improve the ionic conductivity at the outer periphery adjacent to the bent portion where the gel polymer electrolyte tends to become highly viscous and therefore highly resistive. Thus, it is possible to reduce unevenness in the current density of the electrode. As a result, the output characteristics and cycle characteristics of the secondary battery can be improved.

Hereinafter, embodiments for implementing the present disclosure will be described referring to drawings. In each embodiment, the same reference numerals may be given to parts corresponding to matters described in a preceding embodiment, and overlapping explanations may be omitted. In each of the embodiments, when only a part of the configuration is described, the other parts of the configuration can be applied to the other embodiments described above. It is also possible to partially combine the embodiments even when it is not explicitly described, as long as there is no problem in the combination as well as the combination of the parts specifically and explicitly described that the combination is possible.

### First Embodiment

A first embodiment of the present disclosure will be described with reference to the drawings. A secondary battery 1 of this embodiment is a lithium-ion battery in which lithium ions conduct as conductive ions.

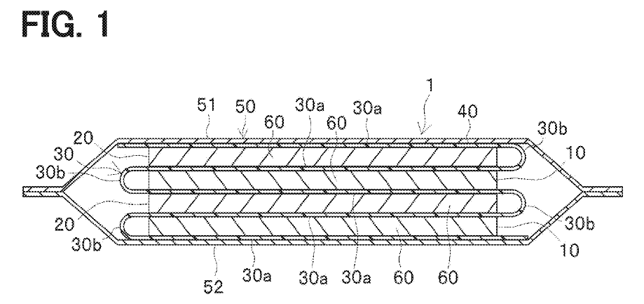

As shown in FIG. 1, the secondary battery 1 includes a positive electrode 10, a negative electrode 20, a separator 30, and an exterior body 50. Hereinafter, the positive electrode 10 and the negative electrode 20 may be referred to as electrodes 10, 20.

The secondary battery 1 is configured as a lamination-type secondary battery in which a laminate 40 is arranged in an exterior body 50. The electrodes 10, 20 and the separator 30 are laminated in the laminate 40. The laminate 40 of the electrodes 10, 20 and the separator 30, together with a gel polymer electrolyte 60, constitutes a battery cell.

The electrodes 10, 20 are formed as flat plate-like member. The number of the positive electrodes 10 and the negative electrodes 20 can be set arbitrarily. In FIG. 1, two positive electrodes 10 and two negative electrodes 20 are laminated.

The separator 30 is formed of a porous body such as a resin porous film, a woven fabric, or a nonwoven fabric. The separator 30 may be made of a nonwoven fabric made of polyolefin resin such as polypropylene or polyethylene, cellulose, aramid, or polyester.

The separator 30 may be surface-coated with a different material, for example, mixtures of ceramic materials such as alumina, titania, boehmite, magnesium hydroxide, and barium sulfate with binders such as PVDF, PTFE, acrylic copolymers, and PVA, or mixtures of resin materials such as meta-aramid and para-aramid with the binders.

In this embodiment, the separator 30 is configured as a single strip-shaped member. The strip-shaped separator 30 is folded in a zigzag shape to have flat portions 30a and bent portions 30b. Hereinafter, the flat portion 30a of the separator 30 may be referred to as separator flat portion 30a, and the bent portion 30b of the separator 30 may referred to as separator bent portion 30b. The separator flat portion 30a is a first portion of the separator 30, and the separator bent portion 30b is a second portion of the separator 30.

The flat portion 30a and the bent portion 30b are formed continuously. The flat portions 30a adjacent to each other are connected by the bent portion 30b.

The flat portions 30a are arranged in parallel to each other. The positive electrodes 10 and the negative electrodes 20 are alternately arranged between the flat portions 30a adjacent to each other. Each of the positive electrode 10 and the negative electrode 20 is interposed between the flat portion 30a, and the flat portion 30a is interposed between the positive electrode 10 and the negative electrode 20. The flat portion 30a are located on both sides of at least one of the positive electrode 10 and the negative electrode 20.

The separator bent portion 30b is formed by bending the separator 30 at location outward of the end of the electrode 10, 20, which is a plate-like member. The separator bent portion 30b is bent to connect the stacked flat portions 30a to each other. The separator bent portion 30b is disposed at a predetermined distance from the end of the electrode 10, 20. Therefore, a gap is formed between the separator bent portion 30b and the end of the electrode 10, 20.

The exterior body 50 is composed of two laminate films 51 and 52 joined together at their outer peripheries to form a housing space therein. The laminate film 51, 52 is provided by laminating, for example, resin layers on both sides of an aluminum foil. The laminate 40 of the electrode 10, 20 and the separator 30 is housed in the housing space of the exterior body 50.

The exterior body 50 houses the laminate 40 of the electrode 10, 20 and the separator 30, as well as the gel polymer electrolyte 60 having ion conductivity. The gel polymer electrolyte 60 is provided from the positive electrode 10 to the negative electrode 20 with the separator 30 interposed therebetween, to permeate the inside of the positive electrode 10 and the inside of the negative electrode 20. The gel polymer electrolyte 60 is a mixture of a polymer compound having a gelling effect and a non-aqueous electrolyte solution, or a polymer compound having both of ion conductivity and gelling effect. The gel polymer electrolyte 60 is a polymer compound that retains a non-aqueous electrolyte solution, and has appropriate plasticity and adhesiveness. The gel polymer electrolyte 60 has ionic conductivity close to that of the non-aqueous electrolyte solution. In the gel polymer electrolyte 60, which is composed of a polymer compound having both of the ion conductivity and the gelling effect, the components forming the electrolyte are made up of a monomer and an electrolyte salt. The gel polymer electrolyte 60 possesses similar plasticity and adhesiveness to gel polymer electrolyte containing a non-aqueous electrolyte solution, except for the ion conductivity, even without the non-aqueous electrolyte solution.

The electrolyte constituent material, which is a raw material of the gel polymer electrolyte 60, is injected into the exterior body 50. After the exterior body 50 is sealed, the gelation proceeds by polymerization inside the exterior body 50, and the gel polymer electrolyte 60 can be obtained. The electrolyte constituent material contains a non-aqueous electrolyte solution and a monomer that is a raw material for a polymer compound having a gelling effect. A polymerization initiator is added to the electrolyte constituent material and heated to a predetermined temperature to start polymerization of the monomer contained in the electrolyte constituent material.

By injecting the electrolyte constituent material into the exterior body 50 in advance, the electrolyte constituent material permeates into the electrode 10, 20. By polymerizing the electrolyte constituent material in this state to produce the gel polymer electrolyte 60, the electrolyte can be constantly retained inside the positive electrode 10 and the negative electrode 20, allowing the charge and discharge reactions to proceed smoothly.

Examples of polymer compounds having a gelling effect include fluororesins containing vinylidene fluoride units, acrylic resins containing (meth)acrylic acid and/or (meth)acrylic acid ester units, and polyether resins containing polyalkylene oxide units. Examples of fluororesins containing vinylidene fluoride units include polyvinylidene fluoride, copolymers containing vinylidene fluoride units and hexafluoropropylene units, and copolymers containing vinylidene fluoride units and trifluoroethylene units. Furthermore, polymer compounds used in polymer electrolytes having both of the ion conductivity and the gelling effect (for example, compounds having an alkylene oxide structure) may be used. For example, polyethylene oxide, polyethylene carbonate, polyethylene succinate, polyphenylene sulfide, polyethyleneimine, or poly(1,3-dioxolane) may be used.

The non-aqueous electrolyte contains a lithium salt and a solvent that dissolves the lithium salt. Examples of lithium salts that can be used include LiPF₆, LiBF₄, LiClO₄, Li(FSO₂)₂N, Li(CF₃SO₂)(FSO₂)N, Li(CF₃SO₂)₂N, LiC(CF₃SO₂)₃, LiBF₂(C₂O₄), and LiB(C₂O₄)₂. The lithium salt may be used alone or in combination of two or more kinds.

As the solvent, one or a mixture of two or more of organic solvents can be used. The organic solvents may be cyclic carbonates such as ethylene carbonate, propylene carbonate, vinylene carbonate, butylene carbonate, and/or chain carbonates such as ethyl methyl carbonate (EMC), diethyl carbonate (DEC), dimethyl carbonate (DMC), dipropyl carbonate (DPC). As the solvent, ionic liquid may be used, which contains, for example, ammonium salts, imidazolium salts, sulfonium salts, piperidinium salts, pyridinium salts, pyrrolidinium salts, phosphonium salts, or morpholinium salts.

As the polymerization initiator, for example, 2,2'-azobisbutyronitrile or benzoyl peroxide can be used in the case of radical polymerization. In case of cationic polymerization, for example, benzenesulfonate or alkyl sulfonium salt can be used. The polymerization initiator may be an anion constituting the electrolyte salt of the non-aqueous electrolyte solution, or may utilize hydrofluoric acid, which is a by-product.

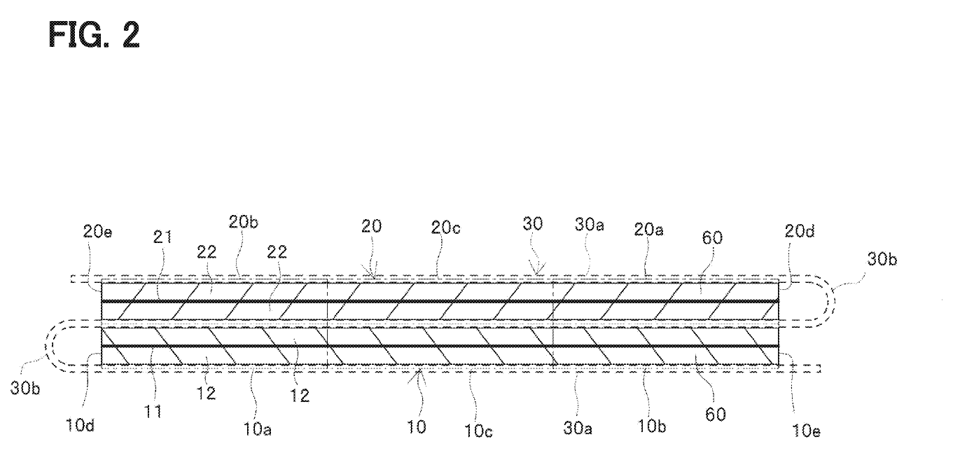

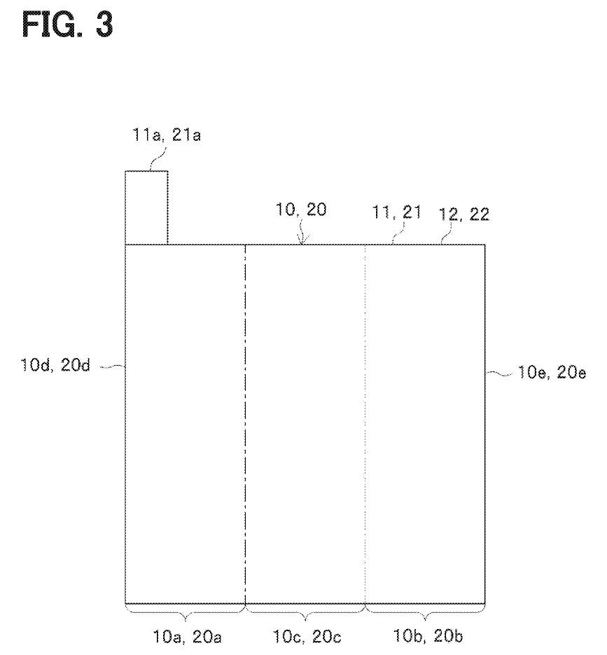

Next, the positive electrode 10 and the negative electrode 20 will be described with reference to FIGS. 2 and 3. FIG. 2 is a cross-sectional view of the positive electrode 10 and the negative electrode 20. FIG. 3 is a plan view of the positive electrode 10 and the negative electrode 20.

As shown in FIG. 3, each of the positive electrode 10 and the negative electrode 20 is a substantially rectangular plate-like member. As shown in FIGS. 2 and 3, the positive electrode 10 has three regions consisting of a first peripheral portion 10a, a second peripheral portion 10b, and a core portion 10c. The first peripheral portion 10a, the second peripheral portion 10b, and the core portion 10c are aligned along a connection direction connecting the first end 10d closer to the separator bent portion 30b and the second end 10e farther from the separator bent portion 30b. The connection direction connecting the first end 10d and the second end 10e is perpendicular to a stacking direction in which the positive electrode 10 and the negative electrode 20 are stacked. The connection direction intersects with the separator bent portion 30b, and corresponds to a left-right direction in FIGS. 2 and 3.

The first peripheral portion 10a is a region that includes the first end 10d of the positive electrode 10. The first peripheral portion 10a is a region of the positive electrode 10 that includes the first end 10d and has a length of 1/3 or less of the positive electrode 10 in the connection direction connecting the first end 10d and the second end 10e.

The second peripheral portion 10b is a region that includes the second end 10e of the positive electrode 10. The second peripheral portion 10b is a region of the positive electrode 10 that includes the second end 10e and has a length of 1/3 or less of the positive electrode 10 in the connection direction connecting the first end 10d and the second end 10e.

The core portion 10c is a region located in the center of the positive electrode 10 in the connection direction connecting the first end 10d and the second end 10e, and is a region interposed between the first peripheral portion 10a and the second peripheral portion 10b.

The negative electrode 20 has three regions consisting of a first peripheral portion 20a, a second peripheral portion 20b, and a core portion 20c. The first peripheral portion 20a, the second peripheral portion 20b, and the core portion 20c are aligned in a connection direction connecting the first end 20d closer to the separator bent portion 30b and the second end 20e farther from the separator bent portion 30b. The connection direction connecting the first end 20d and the second end 20e is the same as the connection direction connecting the first end 10d and the second end 10e.

The first peripheral portion 20a is a region including the first end 20d of the negative electrode 20. The first peripheral portion 20a is a region of the negative electrode 20 that includes the first end 20d and has a length of 1/3 or less of the negative electrode 20 in the connection direction connecting the first end 20d and the second end 20e.

The second peripheral portion 20b is a region that includes the second end 20e of the negative electrode 20. The second peripheral portion 20b is a region of the negative electrode 20 that includes the second end 20e and has a length of 1/3 or less of the negative electrode 20 in the connection direction connecting the first end 20d and the second end 20e.

The core portion 20c is a region located in the center of the negative electrode 20 in the connection direction connecting the first end 20d and the second end 20e, and is a region interposed between the first peripheral portion 20a and the second peripheral portion 20b.

The first peripheral portion 10a, 20a is a bent-side peripheral portion. The second peripheral portion 10b, 20b is an opposite-side peripheral portion. The first end 10d, 20d is a bent-side end. The second end 10e, 20e is an opposite-side end.

As described above, the viscosity of the gel polymer electrolyte 60 increases in the peripheral portions 10a, 10b, 20a, 20b, and the ion transport resistance tends to increase. At the first peripheral portion 10a and the first peripheral portion 20a close to the separator bent portion 30b, the resistance is likely to increase as the viscosity of the gel polymer electrolyte 60 increases.

The positive electrode 10 includes a positive electrode current collector 11 and a positive electrode material 12. A layer of the positive electrode material 12 is formed on both sides of the positive electrode current collector 11. The negative electrode 20 includes a negative electrode current collector 21 and a negative electrode material 22. A layer of the negative electrode material 22 is formed on both sides of the negative electrode current collector 21.

The positive electrode current collector 11 has a positive electrode terminal 11a. The positive electrode terminal 11a is not provided with the positive electrode material 12. The negative electrode current collector 21 has a negative electrode terminal 21a. The negative electrode terminal 21a is not provided with the negative electrode material 22.

The positive electrode current collector 11 may be made of, for example, aluminum, stainless steel, nickel, titanium, or an alloy thereof. The negative electrode current collector 21 may be made of, for example, copper, stainless steel, nickel, titanium, or an alloy thereof.

The positive electrode material 12 includes a positive electrode active material 13 and an inorganic solid electrolyte 70. In the first peripheral portion 10a, the positive electrode material 12 contains the positive electrode active material 13 and the inorganic solid electrolyte 70. In the second peripheral portion 10b and the core portion 10c, the positive electrode material 12 contains the positive electrode active material 13 and does not contain the inorganic solid electrolyte 70. That is, the first peripheral portion 10a, the second peripheral portion 10b, and the core portion 10c are different in the presence or absence of the inorganic solid electrolyte 70 or in the amount of the inorganic solid electrolyte 70 contained therein. The thickness of the positive electrode material 12 is preferably 0.02 mm or more and 0.2 mm or less, and more preferably 0.04 mm or more and 0.1 mm or less.

The negative electrode material 22 contains a negative electrode active material 23 and the inorganic solid electrolyte 70. In the first peripheral portion 20a, the negative electrode material 22 contains the negative electrode active material 23 and the inorganic solid electrolyte 70. In the second peripheral portion 20b and the core portion 20c, the negative electrode material 22 contains the negative electrode active material 23 and does not contain the inorganic solid electrolyte 70. That is, the first peripheral portion 20a, the second peripheral portion 20b, and the core portion 20c are different in the presence or absence of the inorganic solid electrolyte 70 or in the amount of the inorganic solid electrolyte 70 contained therein. The thickness of the negative electrode material 22 is preferably 0.02 mm or more and 0.15 mm or less, and more preferably 0.03 mm or more and 0.8 mm or less.

In the positive electrode 10, the inorganic solid electrolyte 70 can be provided on the positive electrode material 12 in any manner. Similarly, in the negative electrode 20, the inorganic solid electrolyte 70 can be provided on the negative electrode material 22 in any manner.

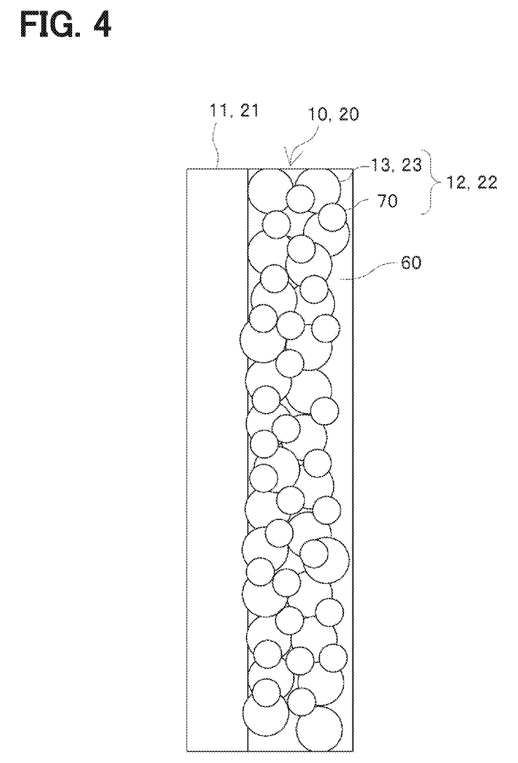

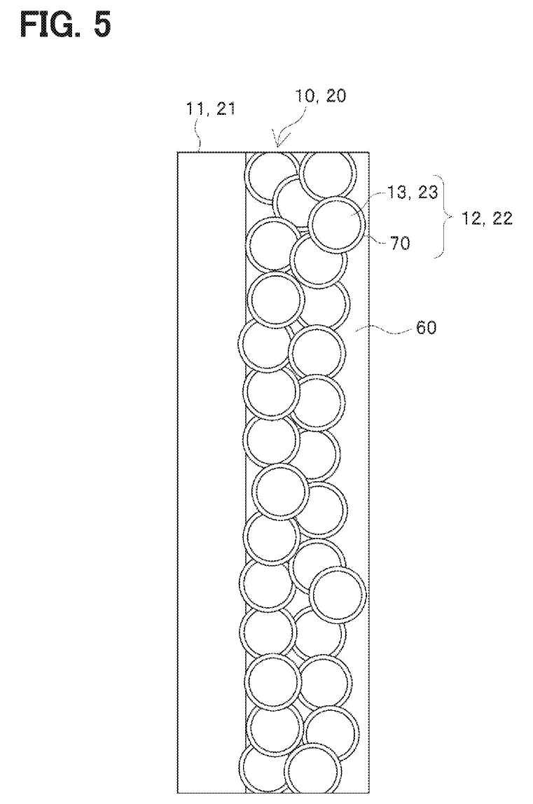

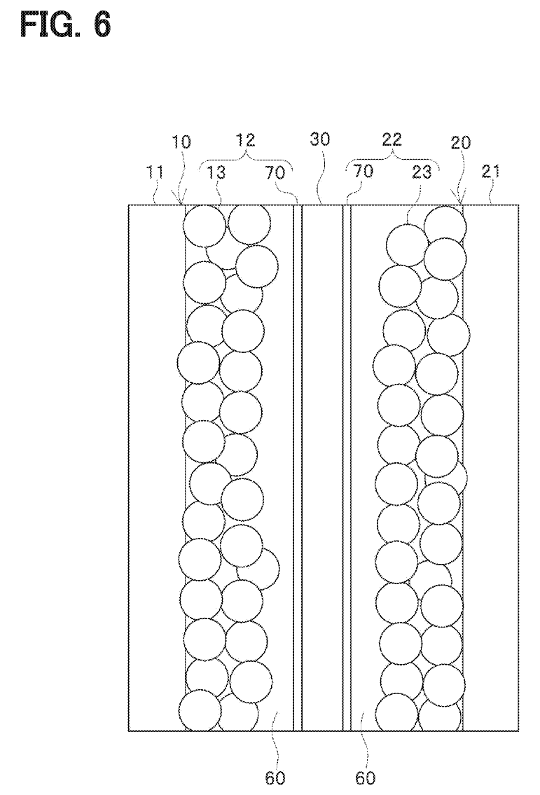

For example, as shown in FIG. 4, the inorganic solid electrolyte 70 may be dispersed in the positive electrode material 12 together with the positive electrode active material 13. The inorganic solid electrolyte 70 may be dispersed in the negative electrode material 22 together with the negative electrode active material 23. As shown in FIG. 5, the inorganic solid electrolyte 70 may be provided to cover the surface of the positive electrode active material 13. The inorganic solid electrolyte 70 may be provided to cover the surface of the negative electrode active material 23. As shown in FIG. 6, the inorganic solid electrolyte 70 may be provided to cover the surface of the separator 30 adjacent to the positive electrode 10. The inorganic solid electrolyte 70 may be provided to cover the surface of the separator 30 adjacent to the negative electrode 20.

The inorganic solid electrolyte 70 has ion conductivity. In the positive electrode 10, the first peripheral portion 10a having a large resistance contains the inorganic solid electrolyte 70, so that the ionic conductivity of the first peripheral portion 10a can be increased. As a result, the unevenness in current density of the positive electrode 10 can be reduced. Similarly, in the negative electrode 20, the first peripheral portion 20a having a large resistance contains the inorganic solid electrolyte 70, so that the ionic conductivity of the first peripheral portion 20a can be increased. As a result, the unevenness in current density of the negative electrode 20 can be reduced.

As the positive electrode active material 13, any material that can be used as the positive electrode active material 13 for a lithium-ion battery can be used. As the positive electrode active material 13, for example, a layered rock salt type active material, an olivine type active material, or a spinel type active material can be used. Examples of the layered rock salt type active material include ternary positive electrode materials such as LiNiₓCo_{y}Mn_{z}O₂ (NCM) and LiNiₓCo_{y}Al_{z}O₂ (NCA). Examples of the olivine type active material include LiFePO₄ (LFP), LiMn₁₋ₓFeₓPO₄ (LMFP), LiMnPO₄ (LMP), LiCoPO₄ (LCP), and LiNiPO₄ (LNP). Examples of the spinel type active material include LiMn₂O₄ (LMO) and LiNi_{0.5}Mn_{1.5}O₄ (LNMO).

As the negative electrode active material 23, a material that can be used as the negative electrode active material 23 for a lithium-ion battery is used. The negative electrode active material 23 may be, for example, a carbon-based negative electrode material such as graphite, amorphous carbon, fullerene, or carbon nanotube; a lithium metal material; a metal-based negative electrode material such as silicon or tin; an oxide-based negative electrode material such as Nb₂O₅ or TiO₂; or a composite of these.

As the inorganic solid electrolyte 70 added to the positive electrode material 12 and the negative electrode material 22, for example, a sulfide-based solid electrolyte or an oxide-based solid electrolyte can be used. As the sulfide-based solid electrolyte, for example, an argyrodite-type solid electrolyte can be used. As the oxide-based solid electrolyte, for example, a garnet-type solid electrolyte, a NASICON-type solid electrolyte, a LISICON-type solid electrolyte, or a pyrochlore-type solid electrolyte can be used. The pyrochlore-type solid electrolyte will be described in detail later.

As the argyrodite-type solid electrolyte, for example, Li₆PS₅Cl can be used. As the garnet-type solid electrolyte, for example, Li₇La₃Zr₂O₁₂ (LLZ) can be used. As the NASICON-type solid electrolyte, for example, Li_{1.4}Al_{0.4}Ti_{1.6}(PO₄)₃ (LATP) can be used. As the LISICON-type solid electrolyte, for example, Li₂₊₂ₓZn₁₋ₓGeO₄ can be used. As the pyrochlore-type solid electrolyte, for example, Li_{1.25}La_{0.58}Nb₂O₆F (LLNOF) and Li_{1.25}La_{0.58}Ta₂O₆F (LLTOF) can be used. The oxide-based solid electrolyte can suppress partial decomposition due to reaction with the gel polymer electrolyte 60 more effectively than the sulfide-based solid electrolyte. For this reason, it is desirable to use an oxide-based solid electrolyte as the inorganic solid electrolyte 70.

The amount of the inorganic solid electrolyte 70 contained in the positive electrode 10 and the negative electrode 20 may be the same or different. The amount of the inorganic solid electrolyte 70 contained in the positive electrode 10 and the negative electrode 20 is preferably such that the positive electrode 10 is greater than the negative electrode 20. Since the positive electrode 10 has a higher interfacial resistance between the electrode and the electrolyte than the negative electrode 20, the ionic conductivity of the positive electrode 10 can be increased by making the amount of the inorganic solid electrolyte 70 in the positive electrode 10 greater than that in the negative electrode 20. Thus, unevenness in current density can be more effectively reduced.

Next, the pyrochlore-type solid electrolyte used as the inorganic solid electrolyte 70 will be described. The pyrochlore-type solid electrolyte of this embodiment has a pyrochlore structure represented by composition formula of Aa_{2-α}Ab_{(1+α)/3}B₂O_{7-β}X_{γ}. In the composition formula, O represents an oxygen atom, and Aa, Ab, B, and X represent any elements or groups. Aa, Ab, and B are different types of cations, while O and X are different types of anions. Aa is an alkali metal cation. The pyrochlore-type solid electrolyte contains plural cations in its composition, which are an alkali metal cation Aa and plural cations Ab and B other than the alkali metal cation Aa. In other words, the pyrochlore-type solid electrolyte contains plural cations including the alkali metal cation Aa in its composition.

The pyrochlore-type solid electrolyte has a crystal structure in which a three-dimensional network of octahedra made of BO₆ is formed. BO₆ consists of a cation B at the center with O positioned at the vertices, and shares vertices with adjacent BO₆. In the three-dimensional network consisting of BO₆, a hexagonal tunnel structure is formed where cation A and anion X are positioned.

In the composition formula, 0.6<α<2.0, 0<β≤1, and 0<γ≤1 are satisfied. As α changes, the composition ratio of Aa to Ab changes. As β and γ change, the composition ratio of O to X changes.

The cation Aa is an alkali metal cation. As the alkali metal represented by Aa, any one of Li, Na, K, Rb, or Cs can be used. As the cation Aa, Mg or H other than alkali metals may also be used. In other words, the cation Aa includes at least one selected from Li, Na, K, Rb, Cs, Mg, and H. In this embodiment, Li is used as Aa. The composition ratio (2-α) of Aa falls within the range of 0<(2-α)<1.4.

The cation Ab includes at least a lanthanoid. As the lanthanoid represented by Ab, at least one of La, Ce, Nd, or Sm can be used. In this embodiment, La is used as Ab. The composition ratio (1+α)/3 of Ab falls within the range of 0.53<(1+α)/3<1.

The basic structure of the cation Ab consists of a lanthanoid. However, a portion of the lanthanoid constituting Ab may be substituted with an alkaline earth metal (such as Ca, Mg, or Sr). In the pyrochlore-type solid electrolyte of this embodiment, a lanthanide included in the pyrochlore structure with the composition formula satisfies 0.6<α<2.0 and 0<β≤1 generates defects in the crystal structure, which is thought to result in improved ionic conductivity. In this embodiment, La is used as Ab.

In the pyrochlore-type solid electrolyte of this embodiment, the cation A in the composition formula "A₂B₂O₇" of a general pyrochlore structure is a composite cation using lithium metal and a lanthanoid. This is believed to contribute to the improvement of the ionic conductivity of the pyrochlore-type solid electrolyte.

The cation B is a metal cation different from Aa and Ab, selected from transition metals or metals from Group 13 to Group 15. The cation B forms an octahedron surrounded by six O atoms within the crystal. As the transition metal represented by B, Group 4 or Group 5 transition metal can be used, and more specifically, at least one of Nb, Ta, Ti, Zr, Hf, or V can be used. As Group 13 element represented by B, Al, Ga, or In can be used. As Group 14 element, Ge or Sn can be used. As Group 15 element, Sb or Bi can be used. In this embodiment, Nb or Ta is used as B.

The anion X is an anion that can substitute for the O atoms constituting the pyrochlore structure. The anion X has different electronegativity and polarizability compared to the O atom. As the anion represented by X, at least one of O, F, Cl, Br, I, S, OH, or P can be used. The composition ratio γ of X falls in the range of 0<γ≤1, and at least a part of the O atoms constituting the pyrochlore structure is substituted with X. In this embodiment, F is used as X.

The pyrochlore-type solid electrolyte of the present embodiment has a defect structure in which lattice defects are included in the crystal by replacing a part of O atoms constituting the pyrochlore structure with anions having electronegativity and polarizability different from those of the O atoms. The pyrochlore-type solid electrolyte of the present embodiment is considered to have improved ion conductivity because the pyrochlore structure includes the defective structure.

In the pyrochlore-type solid electrolyte of the present embodiment, Aa and Ab are partially deficient as a defect structure. The general formula for a pyrochlore structure is A₂B₂O₇, and the compositional ratio of the cation A is 2. In contrast, in the pyrochlore-type solid electrolyte of the present embodiment, the composition ratios of Aa and Ab are “2-α” and “(1+α)/3”, respectively, and 0.6<α<2.0 is satisfied, so that the total composition ratio of Aa and Ab is less than 2. That is, in the crystal structure of the pyrochlore-type solid electrolyte of this embodiment, at least one of Aa and Ab is partially deficient. The compositional ratio corresponding to the deficient portions of Aa and Ab is (2α-1)/3.

Apart from the deviation in compositional ratios, a defect structure can be formed by making the sum of the valences of the cations consisting of Aa, Ab, and B, and the anions consisting of O and X, negative in the compositional formula.

The pyrochlore-type solid electrolyte of this embodiment is a composite anion compound in which plural anions, such as O and X, are contained in the pyrochlore structure. Since the anion represented by X is present in the BO₆ coordination octahedral structure, the alkali metal of Aa can be positioned in the center of the space relative to the BO₆ coordination octahedron, without approaching the BO₆ coordination octahedron. Therefore, it is considered that the pyrochlore-type solid electrolyte of the present embodiment has high ion conduction when used by applying an electric field such as a battery.

Since α, β, and γ in the compositional formula affect lattice defects and ionic conductivity, it is desirable to set α, β, and γ within an appropriate range. When the values of α, β, and γ are large, the defect concentration in the crystal lattice increases. However, if the values exceed a certain amount, the concentration of the alkali metal represented by Aa decreases, leading to a reduction in ionic conductivity. Thus, it is desirable to control α within the range of 0.6<α<2.0, β within the range of 0<β≤1, and γ within the range of 0<γ≤1.

Examples of the pyrochlore-type solid electrolyte include Li_{1.25}La_{0.58}Nb₂O₆F (LLNOF) and Li_{1.25}La_{0.58}Ta₂O₆F (LLTOF). LLNOF and LLTOF use Li as the cation Aa, La as the cation Ab, and F as the anion X, with α=0.75, β=1, and γ=1. LLNOF uses Nb as the cation B, and LLTOF uses Ta as the cation B.

The pyrochlore-type solid electrolyte of this embodiment has an ionic conductivity of 1×10⁻³ S/cm or more. In the pyrochlore-type solid electrolyte of this embodiment, a significantly higher ionic conductivity is obtained than in other oxide-type solid electrolytes such as garnet-type oxides.

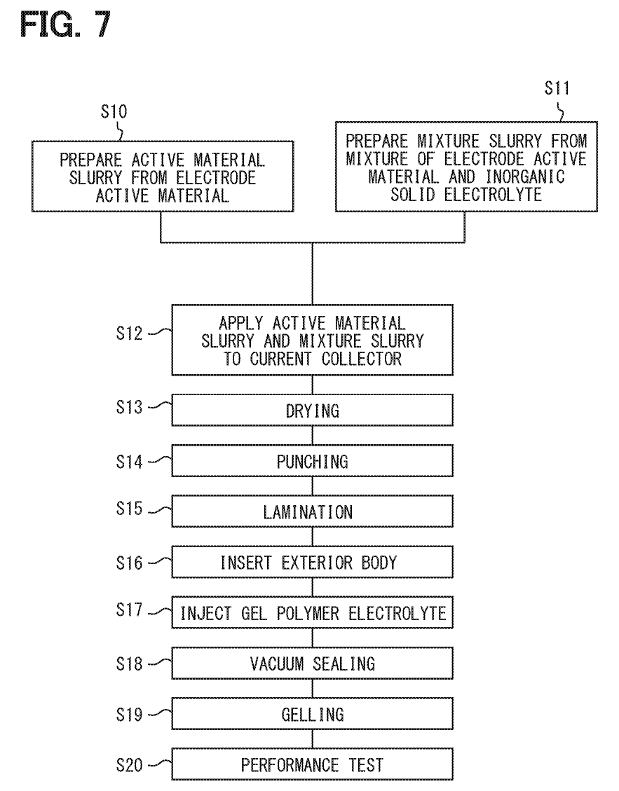

Next, a method for manufacturing the secondary battery 1 of the first embodiment will be described with reference to the flow chart of FIG. 7.

As shown in FIG. 7, in S10, an active material slurry is prepared, in which electrode active materials (positive electrode active material 13, negative electrode active material 23) are dispersed in a solvent. The active material slurry made of the positive electrode active material 13 is used as the positive electrode material 12 for the second peripheral portion 10b and the core portion 10c. The active material slurry made of the negative electrode active material 23 is used as the negative electrode material 22 for the second peripheral portion 20b and the core portion 20c.

In S11 of mixture slurry preparation step, a mixture of the electrode active material 13, 23 and the inorganic solid electrolyte 70 is dispersed in a solvent to prepare a mixture slurry. A mixture slurry prepared from the positive electrode active material 13 and the inorganic solid electrolyte 70 is used as the positive electrode material 12 for the first peripheral portion 10a and the second peripheral portion 10b. A mixture slurry prepared from the negative electrode active material 23 and the inorganic solid electrolyte 70 is used as the negative electrode material 22 for the first peripheral portion 20a and the second peripheral portion 20b.

In S12, a slurry application step is performed in which the active material slurry and the mixture slurry are applied to the positive electrode current collector 11 and the negative electrode current collector 21. In the positive electrode current collector 11, the active material slurry is applied to the areas corresponding to the second peripheral portion 10b and the core portion 10c, and the mixture slurry is applied to the area corresponding to the first peripheral portion 10a. In the negative electrode current collector 21, the active material slurry is applied to the areas corresponding to the second peripheral portion 20b and the core portion 20c, and the mixture slurry is applied to the area corresponding to the first peripheral portion 20a.

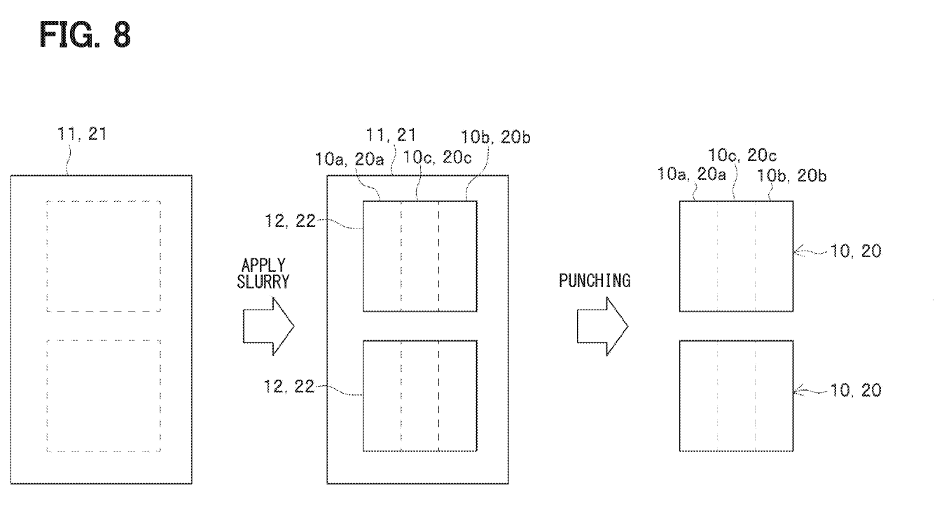

As shown in FIG. 8, the positive electrode current collector 11 and the negative electrode current collector 21 have a size that allows plural positive electrodes 10 and plural negative electrodes 20 to be produced simultaneously. The slurry is applied to the positive electrode current collector 11 at a predetermined interval in an amount equal to the number of the required positive electrodes 10. The slurry is applied to the negative electrode current collector 21 at a predetermined interval in an amount equal to the number of the required negative electrodes 20.

In S13, a drying step is performed in which the slurry applied to the positive electrode current collector 11 and the negative electrode current collector 21 is dried.

In S14, a punching step is performed in which the positive electrode current collector 11 on which the positive electrodes 10 are formed is punched out and divided into plural positive electrodes 10, and the negative electrode current collector 21 on which the negative electrodes 20 are formed is punched out and divided into plural negative electrodes 20.

In S15, a lamination step is performed in which the separator 30 is folded in a zigzag manner, and the positive electrodes 10 and the negative electrodes 20 are alternately laminated with the separator 30 interposed therebetween to form the laminate 40.

In S16, an exterior body insertion step is performed in which the laminate 40 of the positive electrode 10, the negative electrode 20, and the separator 30 is inserted into the internal space of the exterior body 50. The exterior body 50 is in a bonded state in which the outer peripheries of two laminate films 51 and 52 are joined together except for the portion where the laminate 40 is inserted.

In S17, an electrolyte injection step is performed in which an electrolyte constituent material, which is a raw material of the gel polymer electrolyte 60, is injected into the internal space of the exterior body 50. In S18, a vacuum sealing step is performed in which the exterior body 50 is vacuum sealed.

In S19, a gelling step is performed in which the electrolyte constituent material sealed in the exterior body 50 is gelled. In the gelling step, the electrolyte constituent material is heated to a predetermined temperature to initiate polymerization and promote gelling.

In S20, a performance test is carried out on the secondary battery 1 produced in the steps up to S19, and the secondary battery 1 is completed.

According to the first embodiment, in the positive electrode 10 of the lamination-type secondary battery 1, the inorganic solid electrolyte 70 is provided in the first peripheral portion 10a to be connected to the separator bent portion 30b. This makes it possible to improve the ionic conductivity of the first peripheral portion 10a, where the gel polymer electrolyte 60 tends to have a high viscosity and a high resistance, and to reduce unevenness in the current density of the positive electrode 10. As a result, the output characteristics and cycle characteristics of the secondary battery 1 can be improved.

In the first embodiment, the negative electrode 20 of the lamination-type secondary battery 1 is provided with the inorganic solid electrolyte 70 on the first peripheral portion 20a to be connected to the separator bent portion 30b. This makes it possible to improve the ionic conductivity of the first peripheral portion 20a, where the gel polymer electrolyte 60 tends to have a high viscosity and a high resistance, and to reduce unevenness in the current density of the negative electrode 20. As a result, the output characteristics and cycle characteristics of the secondary battery 1 can be improved.

Furthermore, according to the first embodiment, when an oxide-based solid electrolyte is used as the inorganic solid electrolyte 70, partial decomposition due to reaction between the inorganic solid electrolyte 70 and the gel polymer electrolyte 60 can be suppressed more effectively than when a sulfide-based solid electrolyte is used as the inorganic solid electrolyte 70. Therefore, by using an oxide-based solid electrolyte as the inorganic solid electrolyte 70, the unevenness in current density of the positive electrode 10 and the negative electrode 20 can be effectively suppressed.

Furthermore, according to the first embodiment, by using a pyrochlore-type solid electrolyte having high ionic conductivity as the inorganic solid electrolyte 70, the ionic conductivity of the first peripheral portion 10a and the first peripheral portion 20a can be improved, and unevenness in the current density of the positive electrode 10 and the negative electrode 20 can be effectively suppressed.

Furthermore, according to the first embodiment, by providing the inorganic solid electrolyte 70 to the positive electrode 10, which is prone to large interfacial resistance between the electrode and the electrolyte, the ionic conductivity of the positive electrode 10 can be improved and unevenness in current density of the positive electrode 10 can be effectively suppressed.

Furthermore, according to the first embodiment, by providing the inorganic solid electrolyte 70 in both the positive electrode 10 and the negative electrode 20, the ionic conductivity in each of the positive electrode 10 and the negative electrode 20 can be improved, and unevenness in current density can be suppressed.

Furthermore, according to the first embodiment, by making the amount of the inorganic solid electrolyte 70 contained in the positive electrode 10 greater than that in the negative electrode 20, it is possible to preferentially improve the ionic conductivity of the positive electrode 10, which is prone to have large interfacial resistance between the electrode and the electrolyte, and to effectively suppress unevenness in the current density of the positive electrode 10 and the negative electrode 20.

### Second Embodiment

The following describes a second embodiment of the present disclosure. Hereinafter, only portions different from the first embodiment will be described. In the second embodiment, the configurations of the positive electrode material 12 and the negative electrode material 22 are different from those in the first embodiment.

In the second embodiment, the positive electrode material 12 contains the positive electrode active material 13 and the inorganic solid electrolyte 70 in the first peripheral portion 10a and the second peripheral portion 10b. In the core portion 10c, the positive electrode material 12 contains the positive electrode active material 13 and does not contain the inorganic solid electrolyte 70.

In the first peripheral portion 20a and the second peripheral portion 20b, the negative electrode material 22 contains the negative electrode active material and the inorganic solid electrolyte 70. In the core portion 20c, the negative electrode material 22 contains the negative electrode active material 23 and does not contain the inorganic solid electrolyte 70.

The amount of the inorganic solid electrolyte 70 in each of the first peripheral portion 10a and the second peripheral portion 10b may be the same or different. Similarly, the amount of the solid electrolyte in each of the first peripheral portion 20a and the second peripheral portion 20b may be the same or different.

The amount of the inorganic solid electrolyte 70 in the positive electrode 10 is desirably larger in the first peripheral portion 10a than in the second peripheral portion 10b. Since the first peripheral portion 10a tends to have a higher resistance than the second peripheral portion 10b, by increasing the amount of the inorganic solid electrolyte 70 in the first peripheral portion 10a, the ionic conductivity of the first peripheral portion 10a can be increased and unevenness in current density can be more effectively reduced.

Similarly, the amount of the inorganic solid electrolyte 70 in the negative electrode 20 is preferably larger in the first peripheral portion 20a than in the second peripheral portion 20b. Since the first peripheral portion 20a tends to have a higher resistance than the second peripheral portion 20b, by increasing the amount of the inorganic solid electrolyte 70 in the first peripheral portion 20a, the ionic conductivity of the first peripheral portion 20a can be increased and unevenness in current density can be more effectively reduced.

In the lamination-type secondary battery 1 of the second embodiment, the inorganic solid electrolyte 70 is provided on both the first peripheral portion 10a and the second peripheral portion 10b. This makes it possible to improve the ionic conductivity of the peripheral portions 10a, 10b of the positive electrode where the gel polymer electrolyte 60 tends to have a high viscosity and a high resistance, and to reduce unevenness in the current density of the positive electrode 10. As a result, the output characteristics and cycle characteristics of the secondary battery 1 can be improved.

In the second embodiment, the inorganic solid electrolyte 70 is provided on both the first peripheral portion 20a and the second peripheral portion 20b. This makes it possible to improve the ionic conductivity of the peripheral portions 20a, 20b where the gel polymer electrolyte 60 tends to have a high viscosity and a high resistance, and to reduce unevenness in the current density of the negative electrode 20. As a result, the output characteristics and cycle characteristics of the secondary battery 1 can be improved.

Furthermore, according to the second embodiment, by making the amount of the inorganic solid electrolyte 70 in the first peripheral portion 10a greater than that in the second peripheral portion 10b, the ionic conductivity of the first peripheral portion 10a can be increased, and unevenness in the current density of the positive electrode 10 can be more effectively reduced.

Furthermore, according to the second embodiment, by making the amount of the inorganic solid electrolyte 70 in the first peripheral portion 20a greater than that in the second peripheral portion 20b, the ionic conductivity of the first peripheral portion 20a can be increased, and unevenness in the current density of the negative electrode 20 can be more effectively reduced.

### Third Embodiment

The following describes a third embodiment of the present disclosure. Hereinafter, only portions different from the above embodiments will be described. In the third embodiment, the configurations of the positive electrode material 12 and the negative electrode material 22 are different from those in the above embodiments.

In the third embodiment, the positive electrode material 12 contains the positive electrode active material 13 and the inorganic solid electrolyte 70 in the first peripheral portion 10a, the second peripheral portion 10b, and the core portion 10c. That is, in the third embodiment, the inorganic solid electrolyte 70 is added to the entire positive electrode 10.

In the third embodiment, the negative electrode material 22 contains the negative electrode active material 23 and the inorganic solid electrolyte 70 in the first peripheral portion 20a, the second peripheral portion 20b, and the core portion 20c. That is, in the third embodiment, the inorganic solid electrolyte 70 is added to the entire negative electrode 20.

The amount of the inorganic solid electrolyte 70 in each of the first peripheral portion 10a, the second peripheral portion 10b, and the core portion 10c may be the same or different. Similarly, the amount of the solid electrolyte in each of the first peripheral portion 20a, the second peripheral portion 20b, and the core portion 20c may be the same or different.

The amount of the inorganic solid electrolyte 70 in the positive electrode 10 is preferably reduced in the following order of the first peripheral portion 10a, the second peripheral portion 10b, and the core portion 10c. The first peripheral portion 10a is likely to have a higher resistance than the second peripheral portion 10b, and the second peripheral portion 10b is likely to have a higher resistance than the core portion 10c. Therefore, by adjusting the amount of the inorganic solid electrolyte 70 in the positive electrode 10 to set the first peripheral portion 10a to be larger than the second peripheral portion 10b, and to set the second peripheral portion 10b to be larger than the core portion 10c, the unevenness in current density in the positive electrode 10 can be more effectively reduced.

The amount of the inorganic solid electrolyte 70 in the negative electrode 20 is preferably reduced in the following order of the first peripheral portion 20a, the second peripheral portion 20b, and the core portion 20c. The first peripheral portion 20a is likely to have a higher resistance than the second peripheral portion 20b, and the second peripheral portion 20b is likely to have a higher resistance than the core portion 20c. Therefore, by adjusting the amount of the inorganic solid electrolyte 70 in the negative electrode 20 to set the first peripheral portion 20a to be larger than the second peripheral portion 20b, and to set the second peripheral portion 20b to be larger than the core portion 20c, the unevenness in current density in the negative electrode 20 can be more effectively reduced.

According to the third embodiment, the inorganic solid electrolyte 70 is provided on the first peripheral portion 10a, the second peripheral portion 10b, and the core portion 10c. This makes it possible to improve the ionic conductivity throughout the positive electrode 10, and thus improve the output characteristics and cycle characteristics of the secondary battery 1.

Furthermore, according to the third embodiment, the inorganic solid electrolyte 70 is provided on the first peripheral portion 20a, the second peripheral portion 20b, and the core portion 20c. This makes it possible to improve the ionic conductivity throughout the negative electrode 20, and thus improve the output characteristics and cycle characteristics of the secondary battery 1.

### (Examples)

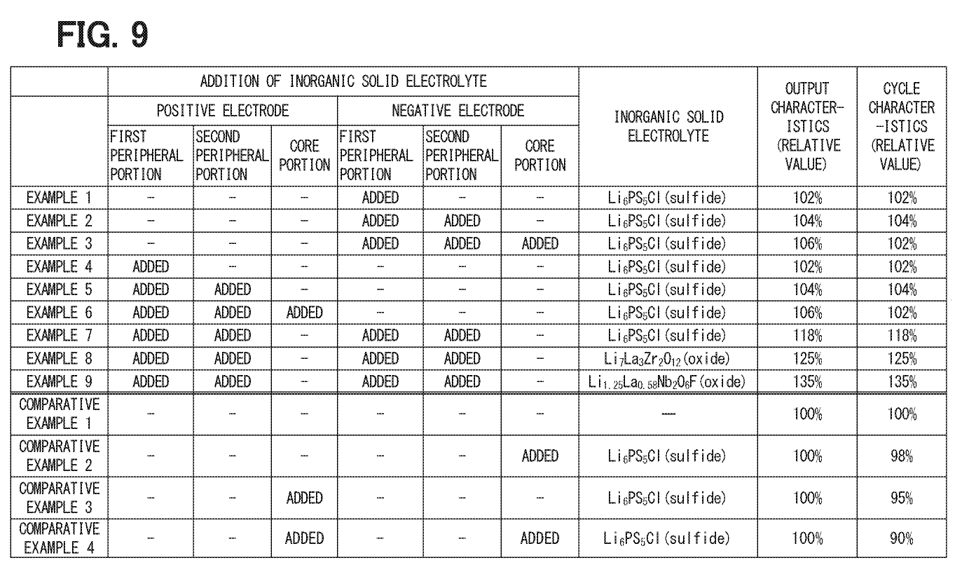

Next, Examples and Comparative examples will be described with reference to FIG. 9. Examples 1 to 9 and Comparative Examples 1 to 4 differ in the region of the inorganic solid electrolyte 70 provided in the positive electrode 10 or the negative electrode 20, or in the type of inorganic solid electrolyte 70. In FIG. 9, the output characteristics and cycle characteristics are shown as relative values when the value of Comparative Example 1 is set to 100%.

The output characteristics and cycle characteristics shown in FIG. 9 are measured using a charge/discharge device manufactured by Hokuto Denko Corporation. The output characteristics in FIG. 9 are evaluated by evaluating the dischargeable time under the conditions of constant current and constant voltage charging at 0.2 C up to 4.3 V in an environment of 25°C, followed by constant current discharging at 10 C up to 2.5 V. The cycle characteristics in FIG. 9 are evaluated by determining the number of cycles at which the discharge capacity became 80% or less of the initial discharge capacity, with one charge-discharge cycle being defined as a constant-current, constant-voltage discharge at 1.0 C to 4.3 V in an environment of 45°C, followed by a constant-current discharge at 7 C to 2.5 V.

In Examples 1 to 9 and Comparative Examples 1 to 4 in FIG. 9, LiNi_{0.8}Co_{0.1}Mn_{0.1}O₂ (NCM811) is used as the positive electrode active material 13, and graphite is used as the negative electrode active material 23. The gel polymer electrolyte 60 used in Examples 1 to 9 and Comparative Examples 1 to 4 contains a vinylidene fluoride copolymer as a polymer, LiPF₆ as a lithium salt, and ethylene carbonate as a solvent.

In Examples 1 to 7, a sulfide-based solid electrolyte is used as the inorganic solid electrolyte 70. In Examples 1 to 7, Li₆PS₅Cl, which is an argyrodite-type solid electrolyte, is used as the sulfide-based solid electrolyte. In Examples 1 to 9 and Comparative Examples 1 to 4, the inorganic solid electrolyte 70 is added at a content rate of 5% when the slurry of the positive electrode material 12 or the negative electrode material 12 is prepared.

In Examples 8 and 9, an oxide-based solid electrolyte is used as the inorganic solid electrolyte 70. In Example 8, Li₇La₃Zr₂O₁₂ (LLZ), which is a garnet-type solid electrolyte, is used as the oxide-based solid electrolyte. In Example 9, Li_{1.25}La_{0.58}Nb₂O₆F (LLNOF), which is a pyrochlore solid electrolyte, is used as the oxide-based solid electrolyte.

In Comparative Example 1, the inorganic solid electrolyte 70 is not used. In Comparative Examples 2 to 4, Li₆PS₅Cl, which is a sulfide-based solid electrolyte, is used as the inorganic solid electrolyte 70.

In the column "addition of inorganic solid electrolyte" in FIG. 9, the portions of the positive electrode 10 and the negative electrode 20 where the inorganic solid electrolyte 70 is provided are indicated as "added," and the portions where the inorganic solid electrolyte 70 is not provided are left blank.

In Example 1, the inorganic solid electrolyte 70 (sulfide) is provided on the first peripheral portion 20a. In Example 2, the inorganic solid electrolyte 70 (sulfide) is provided on the first peripheral portion 20a and the second peripheral portion 20b. In Example 3, the inorganic solid electrolyte 70 (sulfide) is provided on the first peripheral portion 20a, the second peripheral portion 20b, and the core portion 20c.

In Example 4, the inorganic solid electrolyte 70 (sulfide) is provided on the first peripheral portion 10a. In Example 5, the inorganic solid electrolyte 70 (sulfide) is provided on the first peripheral portion 10a and the second peripheral portion 10b. In Example 6, the inorganic solid electrolyte 70 (sulfide) is provided on the first peripheral portion 10a, the second peripheral portion 10b, and the core portion 10c.

In Example 7, the inorganic solid electrolyte 70 (sulfide) is provided on the first peripheral portion 10a, the second peripheral portion 10b, the first peripheral portion 20a, and the second peripheral portion 20b. In Examples 8 and 9, the inorganic solid electrolyte 70 (oxide) is provided on the first peripheral portion 10a, the second peripheral portion 10b, the first peripheral portion 20a, and the second peripheral portion 20b.

In Comparative Example 2, the inorganic solid electrolyte 70 (sulfide) is provided in the core portion 20c. In Comparative Example 3, the inorganic solid electrolyte 70 (sulfide) is provided in the core portion 10c. In Comparative Example 4, the inorganic solid electrolyte 70 (sulfide) is provided in the core portion 20c and the core portion 10c.

As shown in FIG. 9, in all of Examples 1 to 9, the output characteristics and cycle characteristics exceed 100%.

In Example 1, by providing the inorganic solid electrolyte 70 on the first peripheral portion 20a, the output characteristics and cycle characteristics of the secondary battery 1 exceed 100%, and the output characteristics and cycle characteristics of the secondary battery 1 are improved compared to Comparative Example 1. This is believed to be the result of decrease in the ion transport resistance of the first peripheral portion 20a on which the inorganic solid electrolyte 70 is provided, and decrease in the unevenness in current density of the negative electrode 20.

In Example 2, the output characteristics and cycle characteristics of the secondary battery 1 are improved compared to Example 1 by providing the inorganic solid electrolyte 70 on the first peripheral portion 20a and the second peripheral portion 20b. This is believed to be the result of decrease in ion transport resistance of the first peripheral portion 20a and the second peripheral portion 20b, and decrease in the unevenness in current density of the negative electrode 20, compared to Example 1.

In Example 3, the output characteristics of the secondary battery 1 are improved compared to Example 2 by providing the inorganic solid electrolyte 70 in the first peripheral portion 20a, the second peripheral portion 20b, and the core portion 20c. This is believed to be the result of decrease in ion transport resistance in the entire negative electrode 20, resulting in improved output characteristics of the secondary battery 1. On the other hand, in Example 3, the cycle characteristics of the secondary battery 1 is lower than that in Example 2. This is because the ion transport resistance is reduced across the entire negative electrode 20, resulting in a lower degree of improvement in unevenness of current density than in Example 2.

In Example 4, by providing the inorganic solid electrolyte 70 on the first peripheral portion 10a, the output characteristics and cycle characteristics of the secondary battery 1 exceed 100%, and the output characteristics and cycle characteristics of the secondary battery 1 are improved compared to Comparative Example 1. This is due to the fact that the ion transport resistance of the first peripheral portion 10a on which the inorganic solid electrolyte 70 is provided is reduced, and the unevenness in current density of the negative electrode 20 is reduced.

In Example 5, the output characteristics and cycle characteristics of the secondary battery 1 are improved compared to Example 4 by providing the inorganic solid electrolyte 70 on the first peripheral portion 10a and the second peripheral portion 10b. This is believed to be the result of decrease in ion transport resistance of the first peripheral portion 10a and the second peripheral portion 10b, and decrease in unevenness in current density of the negative electrode 20 than in Example 4.

In Example 6, the output characteristics of the secondary battery 1 are improved compared to Example 5 by providing the inorganic solid electrolyte 70 on the first peripheral portion 10a, the second peripheral portion 10b, and the core portion 10c. This is because the ion transport resistance in the entire positive electrode 10 is reduced, resulting in improved output characteristics of the secondary battery 1. On the other hand, in Example 6, the cycle characteristics of the secondary battery 1 are lower than those in Example 5. This is because the ion transport resistance is reduced across the entire negative electrode 20, resulting in a lower degree of improvement in unevenness of current density than in Example 5.

In Example 7, the inorganic solid electrolyte 70 is provided on the first peripheral portion 10a, the second peripheral portion 10b, the first peripheral portion 20a, and the second peripheral portion 20b. In Example 7, the output characteristics and cycle characteristics are higher than those of Example 2 in which the inorganic solid electrolyte 70 is provided on the first peripheral portion 20a and the second peripheral portion 20b. Similarly, in Example 7, the output characteristics and cycle characteristics are higher than those of Example 5 in which the inorganic solid electrolyte 70 is provided on the first peripheral portion 10a and the second peripheral portion 10b. In other words, by providing the inorganic solid electrolyte 70 on both the peripheral portions 10a, 10b and the peripheral portions 20a, 20b, the output characteristics and cycle characteristics can be improved compared to a case in which the inorganic solid electrolyte 70 is provided only on the peripheral portion 10a, 10b or a case in which the inorganic solid electrolyte 70 is provided only on the peripheral portion 20a, 20b.

Examples having the same configuration of the positive electrode 10 and the negative electrode 20 will be compared. In Example 4, in which the inorganic solid electrolyte 70 is provided in the positive electrode 10, the output characteristics and cycle characteristics of the secondary battery 1 are higher than those in Example 1 in which the inorganic solid electrolyte 70 is provided in the negative electrode 20. Similarly, in Example 5 in which the inorganic solid electrolyte 70 is provided in the positive electrode 10, the output characteristics and cycle characteristics of the secondary battery 1 are higher than those in Example 2 in which the inorganic solid electrolyte 70 is provided in the negative electrode 20. Similarly, in Example 6 in which the inorganic solid electrolyte 70 is provided in the positive electrode 10, the output characteristics and cycle characteristics of the secondary battery 1 are higher than those of Example 3 in which the inorganic solid electrolyte 70 is provided in the negative electrode 20. This is because the positive electrode 10 has a higher interfacial resistance between the electrode and the electrolyte than the negative electrode 20. Therefore, the effect of improving the unevenness in current density is greater when the inorganic solid electrolyte 70 is provided in the positive electrode 10 than when the inorganic solid electrolyte 70 is provided in the negative electrode 20.

Example 7, which differs only in the type of inorganic solid electrolyte 70, is compared with Examples 8 and 9. It is found that Examples 8 and 9, which use an oxide-based solid electrolyte, have higher output characteristics and cycle characteristics for the secondary battery 1 than Example 7, which uses a sulfide-based solid electrolyte. This is because, compared with a sulfide-based solid electrolyte, an oxide-based solid electrolyte can be prevented from reacting with the gel polymer electrolyte 60 and partially decomposing. Therefore, the oxide-based solid electrolyte is more effective in improving the unevenness in current density.

Example 8 and Example 9 are compared with each other, which differ only in the type of oxide-based solid electrolyte. Example 9, which uses a pyrochlore-type solid electrolyte (LLNOF), has higher output characteristics and cycle characteristics for the secondary battery 1 than Example 8, which uses a garnet-type solid electrolyte (LLZ). This is due to the high ionic conductivity of the pyrochlore-type solid electrolyte, which improves the effect of improving the unevenness in current density.

In Comparative Examples 2 to 4, the output characteristics are 100%. This is because the resistance of the peripheral portion 20a, 20b and the peripheral portion 10a, 10b, where the inorganic solid electrolyte 70 is not provided, remains unchanged, and the output characteristics do not improve. In Comparative Examples 2 to 4, the cycle characteristics are below 100%. This is believed to be the result of decrease in resistance of the core portion 20c and the core portion 10c in which the inorganic solid electrolyte 70 is provided. Accordingly, the unevenness in current density is increased, and deterioration is advanced in the core portion 20c and the core portion 10c. The deterioration in cycle characteristics is large in Comparative Example 4 in which the inorganic solid electrolyte 70 is provided in both the core portion 20c and the core portion 10c.

### Other Embodiments

The present disclosure is not limited to the above embodiments and can be variously modified as follows without departing from the spirit of the disclosure. Additionally, the means disclosed in each of the embodiments can be appropriately combined within the scope of feasibility.

In the above embodiments, the active material composite particles of the present disclosure are applied to a lithium-ion battery, where the conductive ions are lithium ions, but may be applied to secondary batteries with different conductive ions. Specifically, the active material composite particles of the present disclosure can be applied to potassium-ion batteries where potassium ions conduct, or sodium-ion batteries where sodium ions conduct.

In the first embodiment, the inorganic solid electrolyte 70 is provided on the first peripheral portion 10a and the first peripheral portion 20a, and the inorganic solid electrolyte 70 is not provided on the second peripheral portion 10b and the second peripheral portion 20b. However, a configuration may be adopted in which the inorganic solid electrolyte 70 is not provided on the first peripheral portion 10a and the first peripheral portion 20a, and the inorganic solid electrolyte 70 is provided on the second peripheral portion 10b and the second peripheral portion 20b.

In the above embodiments, the inorganic solid electrolyte 70 is provided in both the positive electrode 10 and the negative electrode 20. However, it is sufficient that the inorganic solid electrolyte 70 is provided in at least one of the positive electrode 10 and the negative electrode 20. When the inorganic solid electrolyte 70 is provided on either the positive electrode 10 or the negative electrode 20, it is desirable to provide the inorganic solid electrolyte 70 on the positive electrode 10, which has a large interfacial resistance between the electrode and the electrolyte.

In the above embodiments, the bent portions 30b are formed on the separator 30 that is zigzag folded, but it is sufficient that at least one bent portion 30b is formed on the separator 30.

What is claimed is:

1. A secondary battery comprising:
an electrode;
a separator;
a gel polymer electrolyte; and
an exterior body that houses the electrode, the separator, and the gel polymer electrolyte, wherein
the electrode has a positive electrode containing a positive electrode active material and a negative electrode containing a negative electrode active material,
the positive electrode and the negative electrode are alternately stacked with the separator interposed therebetween,
the separator has first portions between which at least one of the positive electrode or the negative electrode is arranged, and a second portion bent to connect the first portions,
the electrode has a bent-side peripheral portion including a bent-side end positioned to face the second portion of the separator, and
the bent-side peripheral portion of at least one of the positive electrode or the negative electrode contains an inorganic solid electrolyte.

2. The secondary battery according to claim 1, wherein
the bent-side peripheral portion is a region that includes the bent-side end and has a length that is less than 1/3 of length of the electrode in a connection direction connecting the bent-side end and an opposite-side end farther from the second portion.

3. The secondary battery according to claim 1, wherein
the electrode has an opposite-side peripheral portion including an opposite-side end farther from the second portion, and
the opposite-side peripheral portion contains at least one of the positive electrode active material or the negative electrode active material, and the inorganic solid electrolyte.

4. The secondary battery according to claim 3, wherein
the opposite-side peripheral portion is a region that includes the opposite-side end and has a length that is 1/3 or less of length of the electrode in a connection direction connecting the bent-side end and the opposite-side end.

5. The secondary battery according to claim 4, wherein
an amount of the inorganic solid electrolyte contained in the bent-side peripheral portion is larger than that of the opposite-side peripheral portion.

6. The secondary battery according to claim 3, wherein
the electrode has a core portion between the bent-side peripheral portion and the opposite-side peripheral portion, and
at least one of the positive electrode active material or the negative electrode active material and the inorganic solid electrolyte are added to the core portion.

7. The secondary battery according to claim 6, wherein
an amount of the inorganic solid electrolyte is made smaller in order of the bent-side peripheral portion, the opposite-side peripheral portion, and the core portion.

8. The secondary battery according to claim 1, wherein the positive electrode has the bent-side peripheral portion containing the inorganic solid electrolyte.

9. The secondary battery according to claim 1, wherein each of the positive electrode and the negative electrode has the bent-side peripheral portion containing the inorganic solid electrolyte.

10. The secondary battery according to claim 9, wherein
an amount of the inorganic solid electrolyte contained in the positive electrode is larger than that contained in the negative electrode.

11. The secondary battery according to claim 1, wherein the inorganic solid electrolyte is an oxide-based solid electrolyte.

12. The secondary battery according to claim 11, wherein the oxide-based solid electrolyte is a pyrochlore-type solid electrolyte having a pyrochlore structure.

13. The secondary battery according to claim 12, wherein the pyrochlore-type solid electrolyte has a composition formula of Aa_{2-α}Ab_{(1+α)/3}B₂O_{7-β}X_{γ} , where
Aa is an alkali metal,
Ab contains at least a lanthanoid,
B is a cation different from Aa and Ab, and
X is an anion to be substituted for an O atom of the pyrochlore-type solid electrolyte,
in the composition formula, α is within a range of 0.6<α<2.0, β is within a range of 0<β≤1, and γ is within a range of 0<γ≤1, and
the pyrochlore-type solid electrolyte includes a defect structure.
